(19) United States
(12) Patent Application Publication
(10) Pub. No.: US 2013/0209801 A1
(43) Pub. Date: Aug. 15, 2013

(54) METHOD FOR PRODUCING A MULTILAYER STRUCTURE COMPRISING AN ADHESIVE COMPOSITION BASED ON AN AMYLACEOUS MATERIAL

(71) Applicants: Laurie Coudyser, Raismes (FR); Jean-Luc Monnet, Lille (FR)

(72) Inventors: Laurie Coudyser, Raismes (FR); Jean-Luc Monnet, Lille (FR)

(73) Assignee: Roquette Freres, Lestrem (FR)

(21) Appl. No.: 13/881,768

(22) PCT Filed: Oct. 27, 2011
(86) PCT No.: PCT/FR11/52518

§ 371 Date: Apr. 26, 2013

(30) Foreign Application Priority Data
Oct. 27, 2010 (FR) 10 58838

(51) Int. Cl. C09J 5/06; C09J 7/02

(52) U.S. Cl. CPC C09J 5/06; C09J 7/02
USPC 428/355 BL; 156/244.11

(57) ABSTRACT

A method for producing an article including a multilayer structure containing:—a first layer based on a metal or on an organic polymer;—and a second layer of an adhesive composition including by weight: a) from 15 to 40% of at least one amylaceous material; b) from 10 to 30% by weight of at least one plasticizer for this amylaceous material; c) from 10 to 35% of at least one nongrafted polypropylene; d) from 10 to 35% of at least one polypropylene grafted with a grafting monomer selected from unsaturated carboxylic acid anhydrides, unsaturated carboxylic acids, oxiranes and silanes; these percentages being defined relative to the sum of a, b, c and d; the first and second layers adhering to one another and the method including a step of bringing the adhesive composition into contact in the molten or softened state.

A subject of the present invention is a process for producing an article comprising a multilayer structure including at least one layer of a composition based on an amylaceous material and on polypropylene. Another subject of the invention is the article obtained by means of this process. The invention also relates to the use of said composition as a tie that can be used in the fields of the transformation and processing of plastics, such as extrusion, coextrusion, injection molding, co-injection molding or alternatively overmolding.

In many industrial fields, it is necessary to use multilayer structures in products such as films, pipes or bottles. Layers of different materials can be combined: the multilayer structures can require the combination of various functionalities and each of the layers of the structure brings a particular function to the final structure.

Industrial processes for producing these products comprising these multilayers generally consist of the application of a polymer in the molten state to another layer comprising an organic polymer or a metal.

By way of example, co-injection molded or overmolded products comprising a layer which is smooth to the touch, made of a particular ethylene-co-propylene (EPR) copolymer on a body made of a more rigid high-density polyethylene (HDPE) polymer, are produced, this EPR layer adhering naturally to the HDPE owing to their relatively similar chemical natures and polarities.

It is also possible to produce plastic bottles intended to contain fruit juice by combining a layer of ethylene-co-vinyl alcohol (EVOH) copolymer between two layers of low density polyethylene (LDPE): the layers of LDPE give the structure water-barrier properties and the intermediate layer of EVOH makes it possible to provide gas-barrier properties. Other examples of multilayer structures may be mentioned, such as the “cartons” for the food industry which combine a layer of aluminum with a layer of cardboard, or else pipes for transporting hot water which combine a layer of polyamide (PA) with a layer of polypropylene (PP).

The materials of these layers may be of substantially similar or different chemical nature and polarity.

In the latter case, these various layers do not easily adhesively bond to one another.

The multilayer structures may also comprise several layers of a material of substantially similar chemical nature and polarity, for example several layers of one and the same material: by way of example, since EVOH is a polymer that is not very flexible and is quite “brittle”, various thin layers of EVOH can be combined in one structure: this makes it possible to obtain a more flexible structure in comparison with a structure comprising a single layer of EVOH of thickness equal to the sum of the thicknesses of the thin layers.

An adhesive layer, or tie layer, is therefore used to combine these layers, this tie having to adhere to the materials of the two different layers to be combined with one another.

The structure comprising a layer of EVOH and two layers of LDPE may thus be produced by positioning intermediate layers of polyethylene grafted with maleic anhydride. Likewise, two layers of EVOH may be adhered to one another by means of an intermediate layer of polyethylene grafted with maleic anhydride. To produce the pipe combining PA with PP for transporting hot water, it is possible to use an intermediate layer of polypropylene grafted with maleic anhydride.

When it is desired to produce a multilayer structure, it is therefore necessary:
either to select quite particular materials which naturally adhere to one another;
or to find an appropriate “tie” which makes it possible to adhesively bond various layers to be combined in the structure.

Since the processes for producing multilayer articles used in industry are continuous processes that use increasingly high production rates, it is necessary for these tie layers to adhere very rapidly to the other layers of the structure.

In particular, in the case of techniques for coextrusion of multilayer articles, the layers of thermoplastic polymer constituting the article are brought into contact in the molten or softened state. These techniques are difficult to implement since it is necessary for the adhesive layer in the molten or softened state to have particular properties: in addition to the fact that the composition must be capable of adhering to the various layers of the structure with which it is brought into contact, this composition must also have a fluidity and a dimensional stability in the molten state which allows it to be used in these coextrusion processes. This is necessary in order for the layer of adhesive composition of the structure to be able to retain its dimensions during cooling of the article.

The Applicant had discovered, during its research, that a particular composition based on an amylaceous material and on polypropylene has the ability, when it is in the molten or softened state, to adhere to a multitude of supports, and to do so sufficiently rapidly so that it can be used in continuous industrial processes. Thus, the composition is brought into contact, while hot, with another layer of a support, it being possible for said support layer to be solid or itself in the molten or softened state during this bringing into contact. These supports may be based on a metal or on a thermoplastic or thermoset polymer, which can be polar or nonpolar. This particular composition is therefore of most particular interest for the production of multilayer structures.

Thus, this composition can be used in a process for producing an article comprising a multilayer structure, in which said structure is produced by making various layers adhere to one another, and of which the layer of adhesive composition is in the molten or softened state when it is brought into contact with the other layers.

The invention thus relates to a process for producing an article comprising a multilayer structure containing:
a first layer based on a metal or on an organic polymer;
and a second layer of an adhesive composition comprising by weight:
a) from 15 to 40% of at least one amylaceous material;
b) from 10 to 30% of at least one plasticizer for this amylaceous material;
c) from 10 to 35% of at least one nongrafted polypropylene;
d) from 10 to 35% of at least one polypropylene grafted with a grafting monomer selected from unsaturated carboxylic acid anhydrides, unsaturated carboxylic acids, oxiranes and silanes;
these percentages being defined relative to the sum of a, b, c and d;
   said first and second layers adhering to one another and said process comprising a step of bringing the adhesive composition into contact in the molten or softened state.

The structure according to the invention may also comprise, in addition, a third layer based on a metal or on an organic polymer, the second layer, located between the first and third layers, also adhering to said third layer.

Document WO 2009/022195 describes a composition comprising an amylaceous material, a plasticizer, a polypropylene and a compatibilizer, which can be polypropylene grafted with maleic anhydride. The composition can be used for the production of a monolayer film. It is possible to apply said film to an article made of paper, plastic, wood or composite material. However, this film is not applied while hot to the article. The document does not therefore teach the production of multilayer structures by means of a step of bringing into contact, in the molten or softened state, the composition which is described therein.

Without being bound to any theory, the Applicant partly explains the ability of the adhesive composition according to the invention to adhere to supports as diverse as PP, PE, PA, EVOH, paper or aluminum through the choice of its constituents, in particular proportions, each of these constituents having a polar or nonpolar nature.

The adhesive composition included in the structure according to the invention also has the advantage of being less expensive in comparison with the adhesives normally used in the field. Furthermore, the composition can be printed and labeled and is smooth to the touch. It can also be colored throughout the mass by adding pigments or dyes. The adhesive composition can therefore be used both as an external layer and as an intermediate layer, i.e. a layer located between two other layers. Another advantage of this adhesive composition is that it meets the demand for a product of “biobased” origin since it comprises amylaceous material extracted from plants.

The adhesive composition preferably comprises from 20 to 40% of amylaceous material, from 20 to 30% of plasticizer for this amylaceous material, from 10% to 30% of nongrafted polypropylene and preferably from 10 to 30% of the polypropylene grafted with a grafting monomer.

The grafting monomer may be selected from maleic anhydride, maleic acid, acrylic acid, methacrylic acid, glycidyl methacrylate or glycidyl acrylate.

Preferentially, the grafting monomer is an unsaturated carboxylic acid anhydride, most preferentially maleic anhydride.

The adhesive composition of the second layer may be made up of at least 50% by weight of the constituents a, b, c and d, advantageously at least 80%, preferentially at least 90%.

Advantageously, the adhesive composition of the second layer contains a coupling agent comprising at least two functions which are reactive with respect to the amylaceous material, to the plasticizer or to the grafting monomer.

Among the advantages of this variant, the composition has an even greater capacity for adhesion to the layers with which it is in contact.

The coupling agent may be advantageously selected from polyisocyanates, preferably from diisocyanates, most preferentially from 4,4′-dicyclohexylmethane diisocyanate (H12MDI), methylene diphenyl diisocyanate (MDI), toluene diisocyanate (TDI), naphthalene diisocyanate (NDI), hexamethylene diisocyanate (HMDI) and lysine diisocyanate (LDI).

The coupling agent is advantageously present in the adhesive composition in an amount included in the range of from 0.1 to 15 parts per hundred parts of resin (phr), advantageously from 0.2 to 12 phr, preferentially from 0.5 to 5 phr, the sum of the components a, b, c and d being equal to 100 phr.

At least some, or even all, of the functions of the coupling agent can have reacted with the plasticizer, the amylaceous material and/or the grafting monomer grafted onto the polypropylene.

The reaction of the coupling agent with the plasticizer, the amylaceous material and/or the grafting monomer grafted onto the polypropylene can advantageously be carried out by reactive extrusion.

The adhesive composition advantageously has a melt flow index (MFI) included in the range of from 0.1 to 200 g/10 min (ISO 1133, 190° C., 2.16 kg), for example from 0.2 to 90 g/10 min, preferentially from 0.25 to 50 g/10 min, most preferentially from 0.3 to 10 g/10 min.

The choice of this preferred composition is determined, as will be seen below, by the choice and the proportions of each of its constituents, which makes it possible to obtain an adhesive composition which is even more effective in the coextrusion field.

Advantageously, the plasticizer for the amylaceous material is selected from glycerol, isosorbide, sorbitans, sorbitol, mannitol, polyethylene glycol, polypropylene glycol, or a mixture thereof, the plasticizer preferentially comprising at least 50% by weight of glycerol.

The water content of the adhesive composition relative to its total weight is less than 10% by weight, advantageously less than 5%, preferentially less than 2%. It can be greater than 0.05%, or even than 0.2%. This water content can be determined by the Karl Fischer method, the principle of which is as follows: the Fischer reagent is a methanolic solution of iodine, sulfur dioxide and an amine other than pyridine. In the absence of water, the reagent is stable, but in the presence of water, the sulfur dioxide is oxidized by the iodine according to the reaction:

I₂+SO₂+2H₂O→2IH+H₂ SO₄

There is discoloration of the reagent at the equivalence point.

The organic polymer of the first or third layer can be selected from ethylene homopolymers and copolymers (PE), propylene homopolymers or copolymers (PP), homopolyamides and copolyamides (PA), poly(vinyl alcohol) (PVOH), styrene homopolymers and copolymers (PS), acrylic homopolymers or copolymers, polyesters, chloropolymers and fluoropolymers, polyacetals, polyimides, polysulfones, polycarbonates (PC), polyacrylonitriles, polyurethanes (PU), polyphenylene sulfides (PPS), thermoplastic starches (TPS), or a mixture thereof.

The organic polymer can be:
a polyethylene selected from high density polyethylene (HDPE), low density polyethylene (LDPE), linear low density polyethylene (LLDPE), ethylene-co-vinyl acetate copolymer (EVA), ethylene-co-alkyl acrylate copolymers, ethylene-co-alkyl methacrylate copolymers, ethylene-co-acrylic acid copolymer, ethylene-co-methacrylic acid copolymer, ethylene-co-vinyl alcohol copolymer (EVOH);
poly(vinyl alcohol) (PVOH);
a polypropylene (PP) selected from isotactic polypropylene (iPP) or atactic polypropylene (aPP); or
a polyamide selected from polyamide 6 (PA6), polyamide 6.6 (PA6.6), polyamide 11 (PA11) or polyamide 12 (PA12).

The organic polymer can also be cellulose.

The metal that can form the first or the third layer is preferentially aluminum.

Most preferentially, the first or the third layer is based on polyethylene, on polypropylene, on polyamide, on polyester, on cellulose or on aluminum.

The total number of layers of the structure according to the invention preferentially ranges from 2 to 15 layers, for example from 3 to 11 layers.

Preferred structures of the invention comprise at least one of the following combinations of layers:
LDPE or LLDPE/adhesive composition;
EVOH/adhesive composition;
PP/adhesive composition;
PP/adhesive composition/LDPE or LLDPE;
PA/adhesive composition;
LDPE or LLDPE/adhesive composition/PA;
PP/adhesive composition/PA;
LDPE or LLDPE/adhesive composition/EVOH;
PP/adhesive composition/EVOH;
PA/adhesive composition/EVOH;
Paper or cardboard/adhesive composition;
Aluminum/adhesive composition;
Paper or cardboard/adhesive composition/aluminum;
Paper or cardboard/adhesive composition/aluminum/adhesive composition;
Paper or cardboard/adhesive composition/LLDPE or LDPE;
Paper or cardboard/adhesive composition/PP;
Paper or cardboard/adhesive composition/PA.

The Applicant has noted that the adhesive composition adheres particularly well to ethylene homopolymers and copolymers, in particular those selected from HDPE, LDPE and LLDPE.

The invention also relates to an article comprising the multilayer structure. This article may be a film, a sheet, a punnet, a flask, a bottle, a tank, a pouch, a pipe, tubing, a pail, a box, a dashboard, a tool handle, a door handle or a carpet.

The bringing into contact step of the process for producing this article can be carried out by means of an extrusion, coextrusion, co-injection molding, overmolding, coating, extrusion-coating or extrusion-lamination step, preferentially by means of a coextrusion step.

A particular subject of the invention is a process for producing a film produced by means of a film coextrusion step, for example by coextrusion film blowing, said film being a three-layer film having a PE/adhesive composition/PE structure, preferentially having an LDPE/adhesive composition/LDPE structure.

Another subject of the invention is a process for producing a hollow body, for example a bottle, a flask or a tank, produced by means of a hollow body coextrusion step, said hollow body having a PE/adhesive composition bi-layer structure, preferentially having an HDPE/adhesive composition structure.

The invention also relates to an article obtained using one of the processes described above.

Another subject of the invention is the use of the adhesive composition as described above in an extrusion, coextrusion, injection molding, co-injection molding or else overmolding process for making a material based on a metal or on an organic polymer adhere.

The adhesive composition of use in the invention comprises
from 15 to 40% of at least one amylaceous material;
from 10 to 30% of at least one plasticizer for the amylaceous material;
from 10 to 35% of at least one nongrafted polypropylene; and
from 10 to 35% of at least one polypropylene grafted with a grafting monomer selected from unsaturated carboxylic acid anhydrides, unsaturated carboxylic acids, oxiranes and silanes.

The amylaceous material used in the adhesive composition is preferably selected from granular starches, hydrosoluble starches and organomodified starches.

A granular starch is in the state of semicrystalline granule characteristic of the state in which it is naturally present in the storage organs and tissues of higher plants, in particular in the seeds of cereals, the seeds of leguminous plants, the tubers of potato or of cassava, roots, bulbs, stems and fruits. This natural semicrystalline state is essentially due to the macromolecules of amylopectin, one of the two main constituents of starch. In the native state, the starch grains generally exhibit a degree of crystallinity which ranges from 15 to 45%, and which depends essentially on the botanical origin of the starch and on the possible treatment that it has undergone. Granular starch, placed under polarized light, exhibits by microscopy a characteristic cross, termed “Maltese cross”, which is typical of the crystalline granular state. For a more detailed description of granular starch, reference may be made to chapter II entitled “Structure et morphologie du grain d'amidon” [“Structure and morphology of the starch grain”] by S. Perez, in the book “Initiation à la chimie et à la physicochimie macromoléculaires” [“Introduction to macromolecular chemistry and physicochemistry”], first edition 2000, volume 13, pages 41 to 86, Groupe Francais d'Etudes et d'Applications des Polymères [French group for polymer studies and applications].

The crystallinity of said granular starch can be reduced to 15% or less by a thermomechanical treatment and/or intimate mixing with an appropriate plasticizer. A granular starch may be of any botanical origin. It may be native starch from cereals such as wheat, corn, barley, triticale, sorghum or rice, from tuberous plants such as potato or cassava, or from leguminous plants such as pea and soybean, starches rich in amylose or, conversely, rich in amylopectin (waxy) derived from these plants and any mixtures of the abovementioned starches. The granular starch may also be a granular starch modified by any physical, chemical and/or enzymatic means. It may be a fluidized or oxidized granular starch or a white dextrin. It may also be a granular starch which has been physiochemically modified but has been able to retain the structure of the starting native starch, such as esterified and/or etherified starches, in particular modified by grafting, acetylation, hydroxypropylation, anionization, cationization, crosslinking, phosphation, succinylation and/or silylation. Finally, it may be a starch modified by a combination of the treatments set out above or any mixture of such granular starches. In one preferred embodiment, this granular starch is selected from native starches, fluidized starches, oxidized starches, starches having undergone a chemical modification, white dextrins and any mixtures of these products. The granular starch is preferably a wheat or pea granular starch or a granular derivative of wheat or pea starch. It generally exhibits a content of materials soluble at 20° C. in demineralized water of less than 5% by weight and can be virtually insoluble in cold water.

According to a second variant, the amylaceous material for the preparation of the adhesive composition is a hydrosoluble starch which can also originate from any botanical origin, including a hydrosoluble starch rich in amylase or, conversely, rich in amylopectin (waxy). This soluble starch can be introduced as partial or complete replacement for the granular starch.

For the purposes of the invention, the term “hydrosoluble starch” is intended to mean any starch-derived polysaccharide material which exhibits, at 20° C. and with mechanical stirring for 24 hours, a fraction soluble in demineralized water at least equal to 5% by weight. This soluble fraction is preferably greater than 20% by weight and in particular greater than 50% by weight. Of course, the soluble starch can be completely soluble in demineralized water (soluble fraction=100%).

The hydrosoluble starch is used in solid form, preferably essentially anhydrous solid form, that is to say not dissolved or not dispersed in an aqueous or organic solvent. It is thus important not to confuse, throughout the description which follows, the term “hydrosoluble” with the term “dissolved”.

Such hydrosoluble starches can be obtained by pregelatinization on a drum, by pregelatinization in an extruder, by atomization of an amylaceous suspension or solution, by precipitation with a nonsolvent, by hydrothermal cooking, by chemical functionalization, or the like. It is in particular a pregelatinized, extruded or atomized starch, a highly converted dextrin (also known as yellow dextrin), a maltodextrin, a functionalized starch or a mixture of these products. The pregelatinized starches can be obtained by hydrothermal gelatinization treatment of native starches or modified starches, in particular by steam cooking, jet-cooker cooking, cooking on a drum, cooking in kneader/extruder systems and then drying, for example in an oven, with hot air on a fluidized bed, on a rotating drum, by atomization, by extrusion or by lyophilization. Such starches generally exhibit a solubility in demineralized water at 20° C. of greater than 5% and more generally between 10 and 100% and a degree of starch crystallinity of less than 15%, generally less than 5% and most often less than 1%, or even zero. By way of example, mention may be made of the products produced and sold by the Applicant under the PREGEFLO® brand name.

The highly converted dextrins can be prepared from native or modified starches by dextrinization in a relatively anhydrous acidic medium. They can in particular be soluble white dextrins, or yellow dextrins. By way of example, mention may be made of the products STABILYS® A 053 or TACKIDEX® C 072 produced and sold by the Applicant. Such dextrins exhibit, in demineralized water at 20° C., a solubility generally of between 10 and 95% and a starch crystallinity of less than 15% and generally less than 5%.

The maltodextrins can be obtained by acid, oxidizing or enzymatic hydrolysis of starches in an aqueous medium. They can in particular exhibit a dextrose equivalent (DE) of between 0.5 and 40, preferably between 0.5 and 20 and even better still between 0.5 and 12. Such maltodextrins are, for example, produced and sold by the applicant under the GLUCIDEX® trade name and exhibit a solubility in demineralized water at 20° C. generally of greater than 90%, or even close to 100%, and a starch crystallinity generally of less than 5% and ordinarily of virtually zero.

The functionalized starches can be obtained from a native or modified starch. The high functionalization can, for example, be achieved by esterification or etherification to a sufficiently high level to confer thereon a solubility in water. Such functionalized starches exhibit a soluble fraction as defined above of greater than 5%, preferably greater than 10%, even better still greater than 50%.

The functionalization can be obtained in particular by acetylation in an aqueous phase with acetic anhydride or mixed anhydrides, hydroxypropylation in a tacky phase, cationization in a dry phase or tacky phase, or anionization in a dry phase or tacky phase by phosphation or succinylation. These hydrosoluble highly functionalized starches can exhibit a degree of substitution of between 0.01 and 3, and even better still between 0.05 and 1. Preferably, the reagents for modifying or functionalizing the starch are of renewable origin.

According to another advantageous variant, the hydrosoluble starch is a hydrosoluble wheat or pea starch or a hydrosoluble derivative of a wheat or pea starch.

According to a third variant, the amylaceous material for preparing the adhesive composition is an organomodified starch, preferably an organosoluble starch, which can also come from any botanical origin, including an organomodified starch, preferably an organosoluble starch, rich in amylase or, conversely, rich in amylopectin (waxy). This organosoluble starch can be introduced as partial or complete replacement for the granular starch or for the hydrosoluble starch.

For the purposes of the invention, the term “organomodified starch” is intended to mean any starch-derived polysaccharide material other than a granular starch or a hydrosoluble starch according to the definitions given above. Preferably, this organomodified starch is virtually amorphous, that is to say exhibits a degree of starch crystallinity of less than 5%, generally less than 1% and in particular zero. It is also preferably “organosoluble” that is to say exhibits, at 20° C., a fraction, at least equal to 5% by weight, that is soluble in a solvent selected from ethanol, ethyl acetate, propyl acetate, butyl acetate, diethyl carbonate, propylene carbonate, dimethyl glutarate, triethyl citrate, dibasic esters, dimethyl sulfoxide (DMSO), dimethyl isosorbide, glyceryl triacetate, isosorbide diacetate, isosorbide dioleate and methyl esters of vegetable oils. This soluble fraction is preferably greater than 20% by weight and in particular greater than 50% by weight. Of course, the organosoluble starch can be completely soluble in one or more of the solvents indicated above (soluble fraction=100%).

The organomodified starch can be used according to the invention in solid form, preferably essentially anhydrous form.

The organomodified starch which can be used in the composition according to the invention can be prepared by a high functionalization of native or modified starches such as those presented above. This high functionalization can, for example, be carried out by esterification or etherification to a sufficiently high level to render it essentially amorphous and to confer on it an insolubility in water and preferably a solubility in one of the organic solvents above. Such functionalized starches exhibit a soluble fraction as defined above of greater than 5%, preferably greater than 10%, even better still greater than 50%.

The high functionalization can be obtained in particular by acetylation in a solvent phase with acetic anhydride, grafting, for example in a solvent phase or by reactive extrusion, of acid anhydrides, of mixed anhydrides, of fatty acid chlorides, of oligomers of caprolactones or of lactides, hydroxypropylation and crosslinking in a tacky phase, cationization and crosslinking in a dry phase or in a tacky phase, anionization by phosphation or succinylation and crosslinking in a dry phase or in a tacky phase, silylation, or telomerization with butadiene. These organomodified, preferably organosoluble, highly functionalized starches can in particular be acetates of starches, of dextrins or of maltodextrins or fatty esters of these amylaceous materials (starches, dextrins or maltodextrins) with fatty chains of 4 to 22 carbons, this collection of products preferably exhibiting a degree of substitution (DS) of between 0.5 and 3.0, preferably between 0.8 and 2.8 and in particular between 1.0 and 2.7.

They can, for example, be hexanoates, octanoates, decanoates, laurates, palmitates, oleates and stearates of starches, of dextrins or of maltodextrins, in particular exhibiting a DS of between 0.8 and 2.8.

According to another advantageous variant, the organomodified starch is an organomodified wheat or pea starch or an organomodified derivative of a wheat or pea starch.

The expression “plasticizer for an amylaceous material” is intended to mean any organic molecule preferably having a molecular weight of less than 5000 g/mol, which, when it is incorporated into starch by thermomechanical treatment at a temperature between 20 and 200° C., results in a decrease in the glass transition temperature of the starch and/or in a reduction in the crystallinity of the starch optionally until an essentially amorphous state is reached, that is to say exhibiting a degree of crystallinity of less than 15%, preferably less than 5% and more preferentially less than 1%.

This degree of crystallinity can be measured by X-ray diffraction as described in U.S. Pat. No. 5,362,777 (column 9, lines 8 to 24).

Polyols, in particular sugars such as glucose, maltose, fructose or sucrose, are very effective plasticizers for starch.

The plasticizer of use in the present invention can also be selected from diols, triols and polyols, such as glycerol, polyglycerol, isosorbide, sorbitans, sorbitol, mannitol and hydrogenated glucose syrups, salts of organic acids, such as sodium lactate, urea and mixtures of these products. Water is also a plasticizer for starch. However, the adhesive composition of use in the invention advantageously exhibits, relative to its total weight, a water content of less than 10% by weight, preferentially less than 5%, most preferentially less than 1%. The molar mass of the plasticizer is preferably less than 1000 g/mol, and in particular less than 400; it can be greater than 18 g/mol.

The plasticizer for the starch, most particularly when the latter is organomodified, can be selected from the methyl, ethyl or fatty esters of organic acids, such as lactic acid, citric acid, succinic acid, adipic acid and glutaric acid, and the acetic esters or fatty esters of monoalcohols, diols, triols or polyols, such as ethanol, diethylene glycol, glycerol and sorbitol. By way of example, mention may be made of diglyceryl diacetate (diacetin), glyceryl triacetate (triacetin), isosorbide diacetate, isosorbide dioctanoate, isosorbide dioleate, isosorbide dilaurate, esters of dicarboxylic acids or dibasic esters (DBE), and mixtures of these products. Preferentially, the plasticizer comprises, relative to the total weight of plasticizer, at least 50% of glycerol. In this case, the rest of the plasticizer may be a polyol or a mixture of polyols selected from isosorbide, sorbitans, sorbitol, mannitol and hydrogenated glucose syrups, advantageously sorbitol.

The adhesive composition useful for the invention also comprises a nongrafted polypropylene and also a polypropylene grafted with a grafting monomer.

The polypropylene may be a homopolymer, that is to say it is obtained only from propylene. It may also be a copolymer, that is to say it is obtained from propylene and at least one comonomer capable of copolymerizing with propylene. The propylene advantageously comprises at least 50 mol %, preferentially at least 70 mol %, for example more than 90 mol %, of propylene-derived units. By way of example of comonomers, mention may be made of ethylene, isobutene, 4-methylpentene or 1-butene. The copolymer may be a random copolymer or a block copolymer.

The polypropylene may be isotactic, syndiotactic or atactic, depending on the position of the methyl group on the polymer chain. It is preferentially isotactic. It may be semicrystalline or amorphous. When it is semicrystalline, it may have a melting point included in the range of from 140 to 190° C.

The MFI of the nongrafted polypropylene can range from 0.1 to 500 g/10 min (ISO 1133-190° C.-2.16 kg), for example from 0.3 to 100 g/10 min.

Polypropylene is generally obtained by catalyzed polymerization. Today, catalysts (Ziegler-Natta) which can consist of phthalate/silicon donors or of diether and succinate donors are essentially used. The catalysts may also be “metallocene” catalysts, which are single-site catalysts. They are essentially silica-supported ZrCl₂ catalysts generally used in combination with a cocatalyst such as methylaluminoxane (MAO). These catalysts can be used in combination with Ziegler-Natta catalysts. The polypropylene can be produced in the gas phase or in suspension.

The polypropylene grafted with a grafting monomer is obtained by radical reaction of the grafting monomer with the polypropylene.

For grafting the monomer, one of the polypropylenes mentioned above can be used as polypropylene.

In the polypropylene grafted with the grafting monomer, the weight amount of grafting monomer having reacted with the polypropylene, relative to the weight of the grafted polypropylene, is preferentially between 0.1% and 10%, in particular between 0.5 and 5%. By way of example, the amount of maleic anhydride can be determined conventionally by assaying the succinic functions by Fourier transform infrared (FTIR) spectroscopy. The MFI of the grafted polypropylene is advantageously between 0.1 and 500 g/10 min (ISO 1133-190° C.-2.16 kg), for example between 20 and 250 g/10 min, preferentially between 80 and 240 g/10 min.

Polypropylenes grafted with maleic anhydride are sold by the companies Lyondell-Basell®, Arkema® or else DuPont®.

Various known processes can be used to graft a grafting monomer, for example a maleic anhydride, onto the polypropylene. The grafting can be carried out by heating the polymer at a high temperature, from approximately 100° C. to approximately 300° C., in the presence or absence of a solvent, with or without a radical generator. The radical generators make it possible to facilitate the radical reaction between the grafting monomer and the polypropylene. Peroxides can be used as radical generator. The grafting reaction can be carried out according to a batch solution process or a continuous process with a melt blending device, for example by extrusion.

If the polypropylene carried a grafting monomer in polymerized form and was obtained other than by grafting, for example by copolymerization of the grafting monomer with the other constituent monomers of the polypropylene, this would not of course be a departure from the context of the invention.

According to one variant of the invention, the adhesive composition also comprises a coupling agent, in proportions that can range from 0.1 to 15 parts per hundred parts of resin. This coupling agent can be added to the adhesive composition so as to enable the binding, via covalent bonds, of at least a part of the plasticizer, of the starch or of the grafting monomer grafted onto the polypropylene. This coupling agent can then be selected, for example, from compounds carrying at least two identical or different and free or masked functions selected from isocyanate, carbamoylcaprolactam, aldehyde, epoxide, halo, protonic acid, acid anhydride, acyl halide, oxychloride, trimetaphosphate or alkoxysilane functions and combinations thereof.

It can advantageously be selected from the following compounds:
diisocyanates and polyisocyanates, preferably 4,4′-dicyclohexylmethane diisocyanate (H12MDI), methylene diphenyl diisocyanate (MDI), toluene diisocyanate (TDI), naphthalene diisocyanate (NDI), hexamethylene diisocyanate (HMDI) and lysine diisocyanate (LDI),
dicarbamoylcaprolactams, preferably 1,1′-carbonylbiscaprolactam,
glyoxal, dialdehyde starches and TEMPO-oxidized starches,
diepoxides,
halohydrins, i.e. compounds comprising an epoxide function and a halogen function, preferably epichlorohydrin,
organic diacids, preferably succinic acid, adipic acid, glutaric acid, oxalic acid, malonic acid, maleic acid and the corresponding anhydrides,
oxychlorides, preferably phosphorus oxychloride,
trimetaphosphates, preferably sodium trimetaphoshate,
alkoxysilanes, preferably tetraethoxysilane, and
any mixtures of these compounds.

The composition may also comprise an additional polymer, which may be selected from the organic polymers mentioned hereinafter, and different than the amylaceous material, from the plasticizer, from the nongrafted polypropylene, from the polypropylene grafted with a grafting monomer and from the optional coupling agent included in the adhesive composition. The additional polymer is advantageously present in amounts of less than 70 phr, preferentially less than 20 phr, or even less than 10 phr. This additional polymer may in particular be a polyethylene, such as high density polyethylene (HDPE), low density polyethylene (LDPE) or linear low density polyethylene (LLDPE). The composition may also comprise, in addition, additives that are usual in the production of thermoplastics, capable of improving at least one of the final properties of the composition and/or facilitating the process for producing said composition. The usual additives can be selected from antioxidants, stabilizers, UV absorbers, antistatic agents, optical brighteners, dyes or pigments, nucleating agents, flame retardants, lubricants, antiblocking agents, mold-release agents, anticaking agents, antimicrobial agents, plasticizers, anti-fogging agents and blowing agents. The composition may also comprise, as usual additives, reinforcements or fillers, for example natural vegetable fibers such as wood sawdust, wood fibers or hemp fibers. The composition preferably comprises these additives in amounts of less than 40 phr, or even 20 phr.

The composition can be prepared by mixing in the molten state, using the conventional techniques for producing thermoplastic compositions, using equipment for processing thermoplastics, which is temperature-regulated, such as mixers or extruders. Depending on the choice of the constituents, those skilled in the art know how to select the conditions for producing the composition in order to homogenize the various constituents. The processing temperature can range from 120 to 250° C., for example from 150 to 210° C.

The composition can be prepared in a single step, i.e. the constituents are introduced simultaneously into the processing equipment, or in several steps, for example at various sites of an extruder.

When a coupling agent is introduced into the composition during the production of the latter, the coupling agent can react at least partly with the plasticizer, the amylaceous material and/or the maleic anhydride grafted onto the polypropylene. It should be noted that, when the coupling agent has partially or totally reacted, the composition becomes more viscous. The MFI of the composition is preferably between 0.1 and 200 g/10 min. Those skilled in the art can easily adjust the MFI of the adhesive composition by selecting the various constituents thereof and in particular by selecting the constituents a, b, c and d with appropriate fluidity and by appropriately regulating the amount of the coupling agent when it is present.

The structure according to the invention comprises at least one layer based on a metal or on an organic polymer. It is specified that the term “based on” means that the layer comprises at least 10% by weight of said constituent (metal or organic polymer). Preferentially, the layer based on an organic polymer comprises at least 50% by weight of organic polymer, preferentially at least 70%, in particular at least 90% of organic polymer.

By way of organic polymer, mention may be made of:
ethylene homopolymers and copolymers (PE), such as high density polyethylene (HDPE), low density polyethylene (LDPE), linear low density polyethylene (LLDPE), ethylene-co-vinyl acetate copolymer (EVA), ethylene-co-alkyl acrylate copolymers, ethylene-co-alkyl methacrylate copolymers, ethylene-co-acrylic acid copolymer, ethylene-co-methacrylic acid copolymer, ethylene-co-vinyl alcohol copolymer (EVOH);
poly(vinyl alcohol) (PVOH);
propylene homopolymers or copolymers (PP), such as isotactic polypropylene (iPP) or atactic polypropylene (aPP);
homopolyamides and copolyamides (PA), such as polyamide 6 (PA6), polyamide 6.6 (PA6.6), polyamide 11 (PA11) or polyamide 12 (PA12);
styrene homopolymers and copolymers, such as crystal polystyrene, poly(styrene-co-butadiene), poly(styrene-co-acrylonitrile) (SAN), poly(acrylonitrile-co-butadiene-co-styrene) (ABS) or poly(acrylonitrile-co-styrene-co-acrylate) (ASA);
acrylic homopolymers or copolymers, such as poly(methyl acrylate) (PMA) or poly(methyl methacrylate) (PMMA);
polyesters, such as polyethylene terephthalate (PET), polybutylene terephthalate (PBT), poly(glycolic acid) (PGA), poly(lactic acid) (PLA), polycaprolactone (PCL), poly(butylene succinate) (PBS), poly(butylene adipate) (PBA), poly(ethylene succinate) and poly(ethylene adipate);
chloropolymers and fluoropolymers;
polyacetals, such as polyoxymethylenes (POM);
polyimides;
polysulfones;
polycarbonates (PC);
polyacrylonitriles;
polyurethanes (PU);
polyphenylene sulfides (PPS);
thermoplastic starches (TPS);
or a mixture thereof.

The layer based on an organic polymer can also comprise one of the usual additives previously mentioned.

According to one variant, the layer of organic polymer is based on a biobased polymer, i.e. polymers obtained from raw materials of vegetable or animal origin. This may be cellulose or thermoplastic starch which is thermoplastic, polyamides such as PA11, polyesters such as PLA or else polyolefins such as polyethylene.

Of course, the layer based on a polymer is different than the adhesive layer of use in the invention. Preferably, it is not formed by a composition comprising by weight:
a) from 15 to 40% of at least one amylaceous material;
b) from 10 to 30% of at least one plasticizer for this amylaceous material;
c) from 10 to 35% of at least one nongrafted polypropylene;
d) from 10 to 35% of at least one polypropylene grafted with maleic anhydride;
   these percentages being defined relative to the sum of a, b, c and d.

It may in particular be free of polypropylene and of thermoplastic starch. Mention may also be made of cellulose as organic polymer of use in the invention. Among the materials based on cellulose, mention may be made of all types of wood, of modified celluloses, of paper or else of cardboard. Preferentially, the material based on cellulose is selected from modified or unmodified cellulose, paper or cardboard.

The layer based on an organic polymer may be in the form of a film, a woven or a nonwoven.

The layer based on a metal may be metal, a metal alloy or a nonmetallic constituent mixed with a metal, such as silicon doped with at least one metal. As an example of a metal that can be used in the multilayer structure, mention may be made of iron, zinc, copper, lead or aluminum. As an example of an alloy, mention may be made of brass, steels and cast iron. Preferentially, the metal is aluminum.

When functions of the coupling agent are available, i.e. when there are still functions that have not reacted at the time of application of the adhesive composition to the layer based on an organic polymer or on a metal, these functions can optionally react therewith.

Surprisingly, the presence of the coupling agent even further improves the adhesion of the adhesive composition to the supports based on an organic polymer or on a metal, even when at least some of the reactive functions, or even all of the reaction functions, have already reacted at the time the layer of adhesive composition is made to adhere to the layer of organic polymer or of metal.

According to the variant in which the second layer of adhesive composition is between the first and third layer, the first layer can be based on a nonpolar polyolefin and the third layer can be based on a metal or on a polar polymer.

The nature of the various layers and also the thickness of each of these layers are selected according to the type of article to be produced and the functionalities with which it is desired to provide this article.

By way of example, the weight amount of adhesive composition can be between 0.5 and 80% of the total weight of the structure, for example between 1 and 60% by weight, the remaining amount consisting of the other layers based on an organic polymer or on a metal.

The layer of the adhesive composition can have a thickness ranging from 1 μm to 3 cm, for example from 10 μm to 1 cm. The first and third layers based on a metal or on an organic polymer can have a thickness ranging from 1 μm to 3 cm, for example from 10 μm to 1 cm. The total structure can have a thickness ranging from 2 μm to 10 cm.

A film can have a total thickness ranging from 10 μm to 150 μm.

Some structures can have the advantage of being in accordance with the requirements relating to materials intended for contact with foods. They can also have, depending on the use it is desired to make of this structure, a low or high permeability to liquid water, to water vapor, to oxygen, to nitrogen or to carbon dioxide. By way of example, a structure comprising the successive layers LDPE or LLDPE/adhesive layer/LDPE or LLDPE exhibits low permeabilities to liquid water and to water vapor.

Using the structures according to the invention, it is possible to produce any type of article that has been extruded, laminated or stratified or molded, for example by injection molding.

The articles of the present invention can be produced by means of the conventional techniques for producing multilayer structures using polymers in the molten state.

The process of the invention comprises a step of bringing the adhesive composition into contact in the molten or softened state. Generally, those skilled in the art consider that a composition is in the molten or softened state when it has a non-zero melt flow index under temperature and pressure conditions at the time of the bringing into contact. As previously indicated, the composition has, for example, an MFI of between 0.1 and 200 g/10 min.

Preferentially, at the moment the adhesive composition is brought into contact with one of the layers of the structure, the temperature of the adhesive composition ranges from 150 to 250° C., preferentially from 155 to 210° C.

The process according to the invention can comprise a coextrusion step in the case where the materials of the various layers are brought into contact in the molten state. By way of example, mention may be made of the tube coextrusion technique, the profile coextrusion technique, the bottle, flask or tank coextrusion blow molding technique, generally grouped together under the term hollow body coextrusion blow molding technique, the blown film coextrusion technique also called coextrusion film blowing technique, and the cast coextrusion technique.

Depending on the coextrusion technique and machine used during the production process, those skilled in the art will be able to easily select, for the layer in contact with the adhesive composition, an organic polymer having a suitable MFI. By way of example, the organic polymer may have an MFI ranging from 0.1 to 50 g/10 min.

One particular subject of the invention is a three-layer film obtained by coextrusion having the structure PE/adhesive composition/PE, which can be obtained in particular by coextrusion film blowing. Advantageously, this film is a three-layer LDPE/adhesive composition/LDPE film.

The process for producing this film can be carried out conventionally for those skilled in the art, for example by coextrusion film blowing by coextruding the intermediate adhesive composition at a temperature ranging from 150 to 200° C. and the external polyethylene layers of the film at a temperature ranging from 130° C. to 200° C.

The various thicknesses of this three-layer film may be, relative to the total thickness of the film, from 5 to 40% of the first layer of PE (layer A), from 20 to 90% of the adhesive layer (layer B) and from 5 to 40% of the second layer of PE (layer C), the sum of the thicknesses coming to 100%. Preferentially, these thicknesses range from 10 to 30% for layer A, from 50 to 70% for layer B and from 10 to 30% for layer C.

Another preferred subject of the invention is a hollow body, i.e. a bottle, a flask or a tank, having a PE/adhesive composition bilayer structure, and is obtained by coextrusion; preferentially, its structure is HDPE/adhesive composition. Advantageously, the hollow body of the structure has an external layer consisting of adhesive composition and an internal layer consisting of PE. This hollow body is particularly smooth to the touch.

The process for producing this hollow body can be carried out conventionally for those skilled in the art, for example by coextrusion blow molding of a hollow body by coextruding the adhesive composition at a temperature ranging from 150 to 200° C. and the polyethylene layer of the hollow body at a temperature ranging from 130° C. to 200° C.

The hollow body may have a total thickness ranging from 0.4 mm to 4 mm.

The various thicknesses of this hollow body may be, relative to the total thickness of the film, from 1 to 60% of the adhesive layer (layer D) and from 40 to 99% of the second layer of PE (layer E), the sum of the thicknesses coming to 100%. Preferentially, these thicknesses range from 10 to 50% for layer D and from 50 to 90% for layer E.

By way of another example, LDPE, the adhesive composition and EVOH can be coextruded by film blowing or cast coextrusion so as to form a film comprising a structure of LDPE/adhesive composition/EVOH/adhesive composition/LDPE type. It is also possible to carry out coextrusion blow molding of the same structure in order to obtain a bottle.

It is also possible to produce a pipe by coextruding PP, the adhesive composition and PA so as to form a pipe of PA/adhesive composition/PP structure.

The process according to the invention can also comprise a step of applying a layer of polymer in the molten state onto a layer based on an organic polymer, on a metal or on an adhesive composition in the solid state. This step can be carried out by pressing, overmolding, stratification or lamination, extrusion-lamination, coating or extrusion-coating. Preferentially, the layer of polymer applied in the molten state is the adhesive composition.

By way of example, the adhesive composition (in the molten state) can be applied onto solid aluminum by extrusion-coating.

It is also possible to produce an aluminum/adhesive composition/paper structure by extrusion-lamination, by applying the adhesive composition between the aluminum and the paper: the adhesive composition is applied in the molten state onto the paper and the aluminum is laminated onto the adhesive composition which is still in the molten state.

The structure can also be produced by overmolding: using this technique, it is possible to produce, for example, an HDPE/adhesive composition structure: in a first step, a first HDPE part is produced by injection-molding and then, in the second step, the adhesive composition is applied by overmolding of the cooled HDPE part, by overmolding a layer of adhesive composition.

The invention will now be illustrated by the examples which follow. It is specified that these examples do not in any way limit the scope of the invention.

### EXAMPLES

### Preparation of the Adhesive Composition

### Constituents of the Adhesive Composition:

Native starch (component a): “Wheat starch SP” sold by the Applicant, having a water content of approximately 12%;

Plasticizer (component b): “Polysorb® G 84/41/00” sold by the Applicant, composition based on glycerol and on sorbitol, having a water content of approximately 16%;

Polypropylene (component c);

Polypropylene grafted with maleic anhydride (component d);

Coupling agent: methylene diphenyl diisocyanate (MDI).

### Production of the Adhesive Composition:

The adhesive composition (AC) is obtained in the following way: the various constituents are introduced into a TSA brand twin-screw extruder, having a diameter (D) of 26 mm and a length of 50 D, so as to obtain a total material flow rate of 15 kg/h. The extrusion conditions are the following:
Temperature profile (ten heating zones Z1 to Z10): 200° C./120° C./140° C./140° C./160° C./170° C./160° C./150° C./160° C./160° C.,
Screw speed: 200 rpm.

The constituents of the thermoplastic composition are introduced into the extruder in the following way:
the polypropylene and the polypropylene grafted with maleic anhydride in the main hopper of the extruder in Z1 of the extruder;
the plasticizer for the amylaceous component at the zone Z2;
the native starch at the zone Z3;
and the coupling agent at the zone Z7.

The coupling agent is introduced in proportions of approximately 1 phr.

Extraction of water is carried out by slight negative pressure at the zone Z6.

The resulting composition has a density close to 1.11 and an MFI of 1.1 g/10 min (190° C., 2.16 kg). It has a final water content of approximately 0.4% (measured by the Karl-Fischer method). It comprises, by weight, approximately 30% of native starch, 20% of a mixture of glycerol and sorbitol, 25% of polypropylene and 25% of polypropylene grafted with maleic anhydride. Since glycerol, sorbitol and starch are extracted from plants, the composition has a biobased-constituent content of approximately 50%.

### Preparation and Evaluation of a PE/AC/PE Multilayer Film

### Production of the Multilayer Film

A three-layer film having a PE/AC/PE structure is produced from the adhesive composition described above and from the low-density polyethylene Lupolen 2420H (Basell), which corresponds to a film extrusion grade.

The PE/AC/PE three-layer film is produced by blown film coextrusion using a coextruder which has three distinct feed extruders. Each die of the extruder feeds a feed block enabling the layers of PE and of adhesive composition to be brought into contact in the molten state, the molten polymer flows then passing through an annular die, the gap of which is 0.8 mm.

The settings of the three extruders are the following:
Temperature profile: 170° C.-175° C.-180° C. for the heating zones of the three extruders and 180° C.-180° C.-180° C. for the die head heating zones
Screw speed of the extruders=75 revolutions/min
Coextruded film drawing speed=10 m/min
Blow up ratio=1.8
Cooling with external blower

The resulting films come to a total thickness of 30 microns.

The weight ratio of the various layers of the PE/AC/PE film is: 20/60/20. The materials adhere very well to one another since no delamination was observed between the various layers after a peeling test.

### Determination of the Water Vapor Permeability Properties of the Films Formed

In order to evaluate the properties of the multilayer film previously formed, monolayer films acting as controls were prepared. They consist of:
PE,
adhesive composition,
or a mixture by weight of 40% of PE and 60% of adhesive composition (MIXTURE), i.e. a mixture in proportions equivalent to the weight ratio of the multilayer film previously produced.

These monolayer films were produced in the same way as the multilayer film, with the difference that a single feed extruder is used to form the film. The screw and drawing speeds are set in order to obtain the desired thickness of the film.

The water vapor permeabilities of the films are measured according to the

ISO 2528 standard by following the following protocol: dishes containing a desiccant and closed by the material to be tested are placed in a temperature- and humidity-controlled atmosphere. These dishes are weighed at regular intervals of time. The water vapor transmission rate in g/m²/24 h is determined from the increase in mass, when this increase has become proportional to the time interval, by measuring the rate of the straight line of increase in mass as a function of time. Generally, the water vapor permeability increases when the thickness of the film decreases.

Table 1 below gives, for each composition tested, the properties of water vapor permeability measured at a temperature of 23° C. and 50% relative humidity RH.

TABLE 1
Water vapor permeability of the films

| | | | Water vapor |
|---|---|---|---|
| Film studied | | | transmission rate at |
| composition | structure | thickness [μm] | 23° C. - 50% RH [g/m²/24 h] |
| PE | monolayer | 80 | 0.4 |
| PE | monolayer | 35 | 2.6 |
| AC | monolayer | 80 | 2.2 |
| AC | monolayer | 50 | 3.5 |
| MIXTURE | monolayer | 50 | 2.5 |
| PE/AC/PE | three-layer | 30 | 2.4 |

The following observations can be made:
A monolayer film of adhesive composition is much more permeable to water vapor than a film of PE, approximately five times more (respectively 2.2 compared with 0.4 g/m²/24 h at 80 μm).
A monolayer film of the MIXTURE is less permeable than a monolayer film of the adhesive composition (respectively 2.5 compared with 3.5 g/m²/24 h at 50 μm).
The multilayer film according to the invention has a permeability equivalent to the monolayer film of PE (approximately 2.5 g/m²/24 h at approximately 30 μm).
In order to obtain an impermeability equivalent to the multilayer film according to the invention, using a monolayer film of MIXTURE, it is necessary to greatly increase the thickness of the latter: a monolayer film of 50 μm of the MIXTURE has a permeability equivalent to that of the multilayer film according to the invention of 30 μm (2.5 g/m²/24 h).

The PE/AC/PE structure according to the invention is therefore very advantageous from an eco-design point of view since it integrates biobased products and enables a lower material consumption than the monolayer films produced from a mixture of PE and of the adhesive composition.

### Preparation of a Metal/AC/Metal Structure

The Applicant has also carried out work for producing three-layer structures produced by cold pressing from various metals and from the adhesive layer already described, using the following protocol.

Three granules of the adhesive composition are placed between two identical sheets of metal or metal alloy (dimensions: 2 cm×4 cm). The sheets are placed in a heating press with the temperature regulated at 180° C.

The metals and metal alloys tested are:
aluminum,
copper,
brass,
stainless steel,
cast iron,
cast aluminum,
a sheet of a tin/lead soldering alloy.

For all these metals and alloys, excellent adhesion was observed between the various layers.

By way of comparison, when granules of polypropylene are placed between these same supports, no adhesion could be observed.

### Preparation of a Hollow Body Having an HDPE/AC Structure

The structure is produced by coextrusion blow molding of hollow bodies of HDPE and of the adhesive composition.

The HDPE has an MFI of 0.25 measured at 190° C. and 2.16 kg according to the ISO 1133 standard.

The bottles produced have the following structure from the outside to the inside:
1. Adhesive composition
2. HDPE

The bottles are prepared using a Magic coextrusion blow molding line equipped with two distinct extruders, the barrels of which are respectively set at a temperature of 170° C. for the adhesive composition and 180° C. for the HDPE. The extrusion head, comprising the feed block and the die, has a tiered temperature between 185° C. and 160° C.

The external and internal thickness is chosen by modifying the flow rate of the extruders and by thus introducing into the extrusion head more or less HDPE and adhesive composition.

A first coextrusion blow molding is thus carried out, for which a bottle is obtained, the parison of which has a thickness of approximately 1 mm, the respective thicknesses of the two layers being approximately 10% for the adhesive composition and approximately 90% of HDPE.

A second coextrusion blow molding is then carried out, for which a bottle is obtained, the parison of which has a thickness of approximately 1 mm, the respective thicknesses of the two layers being approximately 50% for the adhesive composition and approximately 50% of HDPE.

The two bottles obtained have an excellent appearance and the layers of HDPE and of adhesive composition adhere perfectly to one another. They are also smooth to the touch, this touch being linked to the external layer of adhesive composition.

1-26. (canceled)

27. A process for producing an article comprising a multilayer structure containing:
a first layer based on an organic polymer selected from ethylene homopolymers and copolymers;
and a second layer of an adhesive composition comprising by weight:
a) from 15 to 40% of at least one amylaceous material;
b) from 10 to 30% of at least one plasticizer for this amylaceous material;
c) from 10 to 35% of at least one nongrafted polypropylene;
d) from 10 to 35% of at least one polypropylene grafted with a grafting monomer selected from unsaturated carboxylic acid anhydrides, unsaturated carboxylic acids, oxiranes and silanes;
these percentages being defined relative to the sum of a, b, c and d;
said first and second layers adhering to one another and said process comprising a step of bringing the adhesive composition into contact in the molten or softened state.

28. The process as claimed in claim 27, wherein the multilayer structure comprises, in addition, a third layer based on a metal or on an organic polymer, the second layer, located between the first and third layers, also adhering to said third layer.

29. The process as claimed in claim 27, wherein the adhesive composition comprises from 20 to 40% of amylaceous material, from 20 to 30% of plasticizer for this amylaceous material, from 10 to 30% of nongrafted polypropylene and from 10 to 30% of the polypropylene grafted with a grafting monomer.

30. The process as claimed in claim 27, wherein the grafting monomer is maleic anhydride.

31. The process as claimed in claim 27, wherein at least 50% of the total weight of the adhesive composition of the second layer is made up of a, b, c and d.

32. The process as claimed in claim 27, wherein the adhesive composition also contains a coupling agent comprising at least two functions which are reactive with respect to the plasticizer, to the amylaceous material or to the grafting monomer.

33. The process as claimed in claim 32, wherein the coupling agent is selected from polyisocyanates.

34. The process as claimed in claim 27, wherein the adhesive composition has a melt flow index MFI included in the range of from 0.1 to 200 g/10 min (ISO 1133, 190° C., 2.16 kg).

35. The process as claimed in claim 27, wherein the plasticizer for the amylaceous material is selected from glycerol, isosorbide, sorbitans, sorbitol, mannitol, polyethylene glycol, polypropylene glycol and mixtures thereof.

36. The process as claimed in claim 27, wherein the organic polymer is:
a polyethylene selected from high density polyethylene (HDPE), low density polyethylene (LDPE), linear low density polyethylene (LLDPE), ethylene-co-vinyl acetate copolymer (EVA), ethylene-co-alkyl acrylate copolymers, ethylene-co-alkyl methacrylate copolymers, ethylene-co-acrylic acid copolymer, ethylene-co-methacrylic acid copolymer, ethylene-co-vinyl alcohol copolymer (EVOH).

37. The process as claimed in claim 27, wherein the organic polymer is selected from HDPE, LDPE and LLDPE.

38. The process as claimed in claim 27, wherein the total number of layers ranges from 2 to 15 layers.

39. The process as claimed in claim 27, wherein the structure comprises one of the following combinations of layers:
LDPE or LLDPE/adhesive composition;
PP/adhesive composition/LDPE or LLDPE;
LDPE or LLDPE/adhesive composition/PA;
LDPE or LLDPE/adhesive composition/EVOH.

40. The process as claimed in claim 27, wherein the step of bringing the adhesive composition into contact in the molten or softened state consists of an extrusion, coextrusion, co-injection molding, overmolding, extrusion-coating or extrusion-lamination step.

41. The process as claimed in claim 40, wherein the bringing into contact step is carried out by means of a coextrusion step.

42. The process as claimed in claim 27, wherein the article is a film produced by means of a coextrusion step, and that said film is a three-layer film having a PE/adhesive composition/PE structure.

43. An article obtained according to the process as claimed in claim 27.

44. The process as claimed in claim 34, wherein the adhesive composition has a melt flow index MFI included in the range of from 0.3 to 10 g/10 min (ISO 1133, 190° C., 2.16 kg).

45. The process as claimed in claim 35, wherein the plasticizer comprises at least 50% by weight of glycerol.
